(19) United States
(12) Patent Application Publication
(10) Pub. No.: US 2022/0168970 A1
(43) Pub. Date: Jun. 2, 2022

(54) COMPOSITES PRODUCED WITH A BARRIER PLY AND METHODS FOR MAKING THE SAME

(71) Applicant: U. S. A. as represented by the National Aeronautics and Space Administration, Washington, DC (US)

(72) Inventors: Frank L. Palmieri, Yorktown, VA (US); John W. Connell, Yorktown, VA (US); Robetro J. Cano, Yorktown, VA (US); Tyler B. Hudson, Suffolk, VA (US)

(21) Appl. No.: 17/539,556

(22) Filed: Dec. 1, 2021

Related U.S. Application Data
(60) Provisional application No. 63/119,972, filed on Dec. 1, 2020.

(51) Int. Cl. B29C 70/30

(52) U.S. Cl. CPC B29C 70/30; B29K 2063/00

(57) ABSTRACT

Described herein are composites produced with a barrier ply. The barrier-ply prevents excessive mixing between conventional composite precursors and stoichiometrically-offset precursors during a cure process by gelling early in the cure cycle before extensive mixing can occur. Excess mixing requires the use of thicker offset resin layers with a large stoichiometric offset, which may limit the performance of unitized structures. The use of the barrier plies described herein address this issue and improves the mechanical properties of the final composite product as well as the efficiency for making the composites.

### CROSS-REFERENCE TO RELATED PATENT APPLICATION(S)

This patent application claims the benefit of and priority to U.S. Patent Application No. 63/119,972, filed on Dec. 1, 2020, the contents of which is hereby incorporated by reference in its entirety.

### STATEMENT REGARDING FEDERALLY SPONSORED RESEARCH OR DEVELOPMENT

The invention described herein was made by employees of the United States Government and may be manufactured and used by or for the Government of the United States of America for governmental purposes without the payment of any royalties thereon or therefore.

### BACKGROUND OF THE INVENTION

The commercial air transport fleet is expected to approximately double in size between 2017 and 2035, and efficient, composite structures will be necessary for sustainability. Moreover, lightweight composites are potentially useful in all-electric, on-demand mobility (ODM) vehicles, which will depend on efficient composite structures due to the limitations of battery energy density. To meet the expected demand for new composite airframes in the coming decades, manufacturers must increase productivity by nearly an order of magnitude, which has brought manufacturing rate technical challenges to the forefront of composite materials and processing research.

Polymer matrix composites provide high performance and efficiency needed for aerospace structures because of their excellent specific strength, toughness and stiffness along the fiber. To realize the full performance advantages of composites, complex, built-up structures must be assembled using adhesives; however, uncertainty in bond strength often requires manufacturers to install redundant fasteners or other crack-arrest features to meet Federal Aviation Administration guidelines for certification of primary bonded structure.

The composites manufacturing industry regularly uses three methods to assemble large-scale thermoset composite components: co-cure, co-bond, and secondary bond processes. The co-cure process joins two thermoset composite preforms (uncured components) and cures them together such that the joint is formed as the parts are cured. Co-cure requires a mold or other tooling to support the preform during the cure process. Co-cure results in predictable joint properties and structures can often be certified without redundant fasteners using industry standard methods amenable to high rate manufacturing. However, co-cured processing can be costly and technically challenging to implement on complex and large structures because of specialized mold and tool requirements.

Co-bond and secondary bond processes join a cured, thermoset component with an adhesive film. The adhesive bond between the pre-cured component and the adhesive is inherently sensitive to contamination, which may result in a weak bond. Currently, bond strength can only be measured by destructive test methods, which compels the FAA to require redundant load paths to ensure structural performance. The inherent uncertainty in adhesive bonds stems from the material discontinuity at the composite-to-adhesive interfaces, which is nearly two dimensional and therefore susceptible to minute contamination.

The ideal solution is a material system that enables the manufacture of complex structures using secondary bonding methods, but retains predictable material properties throughout the structure as in co-cured assembly.

### BRIEF SUMMARY OF THE INVENTION

Described herein are composites produced with a barrier ply. The barrier-ply prevents excessive mixing between conventional composite precursors and stoichiometrically-offset precursors during a cure process by gelling early in the cure cycle before extensive mixing can occur. Excess mixing requires the use of thicker offset resin layers with a large stoichiometric offset, which may limit the performance of unitized structures. The use of the barrier plies described herein address this issue and improves the mechanical properties of the final composite product as well as the efficiency for making the composites.

These and other features, advantages, and objects of the present invention will be further understood and appreciated by those skilled in the art by reference to the following specification, claims, and appended drawings.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

FIGS. 1A-1B depict a process for making the composites described herein. FIG. 1A shows the assembly and primary curing step to produce a composite substrate. FIG. 1B shows the assembly and secondary curing step to produce a composite described herein.

FIG. 2 depicts a process for making the composites described herein using a joining ply.

FIG. 3 depicts amplitude ultrasonic inspection (C-scan) results from sample A1 showing delaminations in the center of the laminate indicated by red and yellow splotchy coloration. The rectangular red region on the right is the manufactured precrack required for End Notched Flexure (ENF) testing.

FIG. 4 shows cross-section micrographs of samples A2, C, and E. All micrographs are at the same magnification (˜120×). Location of barrier ply (BP), epoxy rich (ER), and hardener rich (HR) layers indicated with white labels and arrows. The single arrows in sample C indicate visible interface.

### DETAILED DESCRIPTION OF THE INVENTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure. Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of” Similarly, the term “consisting essentially of” is intended to include examples encompassed by the term “consisting of.”

As used in the specification and the appended claims, the singular forms “a,” “an” and “the” include plural referents unless the context clearly dictates otherwise. Thus, for example, reference to “a solvent” include, but are not limited to, mixtures or combinations of two or more such solvents, and the like.

Identifiers such as “first curable resin” and “second curable resin” are provided herein and are used to distinguish different components.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

Disclosed are the components to be used to conduct the methods of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

As used herein, the terms “optional” or “optionally” means that the subsequently described event or circumstance can or cannot occur, and that the description includes instances where said event or circumstance occurs and instances where it does not.

As used herein, the terms “cure” and “curing” encompass polymerizing and/or crosslinking of a resin or polymeric material brought about by mixing of reactive based components with a functionality of two or more, heating at elevated temperatures, and/or exposing the materials to ultraviolet light and radiation.

The term a “fully cured” resin as used herein refers to when the curable no longer undergoes polymerization. As known in the art, even when using the term “fully cured” there may still regularly be some residual functional groups that have not polymerized or cross-linked due to chain end mobility or other known reasons. In some embodiments, a “fully cured” resin or composition may contain less than about 1%, about 0.1%, or about 0.01% residual reactive functional groups as determined by the molar percentage of the initial total moles of functional groups in a material.

In one aspect, the degree of cure (DoC) can be measured by differential scanning calorimetry (DSC). Differential scanning calorimetry (DSC) is used to measure the exotherm due to the enthalpy of polymerization. For example, an uncured (0% degree of cure, DoC) sample is cured in the DSC to the maximum extent of reaction attainable to measure the total heat of reaction (THR). A new sample of the same material at an unknown DoC can be placed in the DSC and put through the same cure process to measure the residual heat of reaction (RHR). The extent of cure of the unknown sample is then taken as (1-RHR/THR)×100%.

In another aspect, the (DoC) can be measured by spectroscopy. Infrared, near infrared, and Raman spectroscopy can be used to quantify the concentrations of reactive functional groups in a polymer. When a clearly discernable peak associated with a limiting functional group can be identified in the spectrum, then it is possible to directly track the consumption of that functional group (and the DoC) by collecting spectral data at various stages of cure. The peak area or peak height can be used to quantify the concentration of the functional group(s) associated with that peak(s).

The term a “partially cured” resin may contain more than about 10%, about 20%, about 30%, about 50%, about 60%, about 70%, about 80%, or about 90% residual reactive functional groups as determined by the molar percentage of the initial total moles of functional groups in the material. The term “partially cured” also refers to the point at which the curable resin is less than the gel point of the curable resin. The term “gel point” as defined herein as the DoC where the polymer first forms an infinite network, the material becomes insoluble, and the material takes on an elastic modulus. In one aspect, the gel point of the curable resin can be measured rheologically using dynamic mechanical analysis (DMA) or a torsional (e.g., parallel plate) rheometer. An oscillatory mechanical test is carried out during the resin cure process. The gel point is identified by the point where the measured storage modulus exceeds the measured loss modulus. During the dynamic testing, the material is heated according to a cure cycle (time and temperature is measured) while the storage and loss moduli are measured. Either DSC or spectral techniques are used to determine the DoC of the material due to the applied cure cycle. Once you have both the rheology and DoC measurements, the DoC at the gel point can be determined.

As used herein, the term “faying surface” is the surface or of a material or layer that interfaces with the faying surface of a second material or layer. The two layers are adjacent to (i.e., in contact with) one another at the faying surface of each layer.

As used herein, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

Unless otherwise specified, temperatures referred to herein are based on atmospheric pressure (i.e. one atmosphere).

It is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

### Composites

Described herein are composites produced with a barrier ply. Not wishing to be bound by theory, the barrier ply reduces mass transfer (e.g., diffusive and convective mixing) between resin impregnated fiber lamellae in a fiber reinforced plastic (FRP) structure with a curable resin. In particular, the barrier-ply prevents excessive mixing between conventional composite precursors and stoichiometrically-offset precursors during a cure process by gelling early in the cure cycle before extensive mixing can occur. Excess mixing requires the use of thicker offset resin layers with a large stoichiometric offset, which may limit the performance of unitized structures. The use of the barrier plies described herein address this issue and improves the mechanical properties of the final composite product as well as the efficiency for making the composites. As will be demonstrated below, the composites produced herein have no detectable interfaces between the different layers used to produce the composites, which in effect significantly reduces the likelihood of the composite from cracking or delaminating.

In one aspect, a method for producing the composites described herein comprises:
(a) providing a first composite substrate and a second composite substrate, wherein the first composite substrate and the second composite substrate each comprises
   (i) a substrate comprising a first curable resin having a first faying surface,
   (ii) a barrier ply comprising a second curable resin adjacent to the first faying surface of the substrate, wherein the barrier ply has a second faying surface, and
   (iii) a bonding ply comprising a third curable resin adjacent to the second faying surface of the barrier ply, wherein the bonding ply has a third faying surface, wherein the substrate and barrier ply in the first composite substrate and the second composite substrate are fully cured and the bonding ply in the first composite substrate and the second composite substrate is partially cured;
(b) (1) coupling the first composite substrate to the second composite substrate, wherein the bonding ply of the first composite substrate is adjacent to the bonding ply of the second composite substrate to produce a first stack, or (2) coupling the first composite substrate to the second composite substrate by a joining ply comprising a fourth curable resin, wherein the bonding ply of the first composite substrate and the second composite substrate is adjacent to a faying surface of the joining ply to produce a first stack; and
(c) curing the first stack to fully cure the bonding ply in the first composite substrate and the second composite substrate to produce the composite.

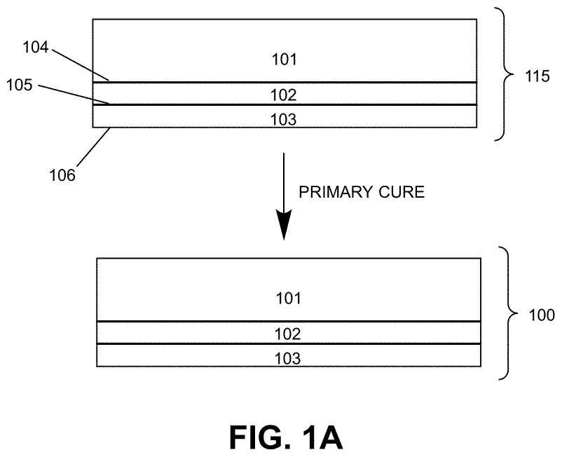

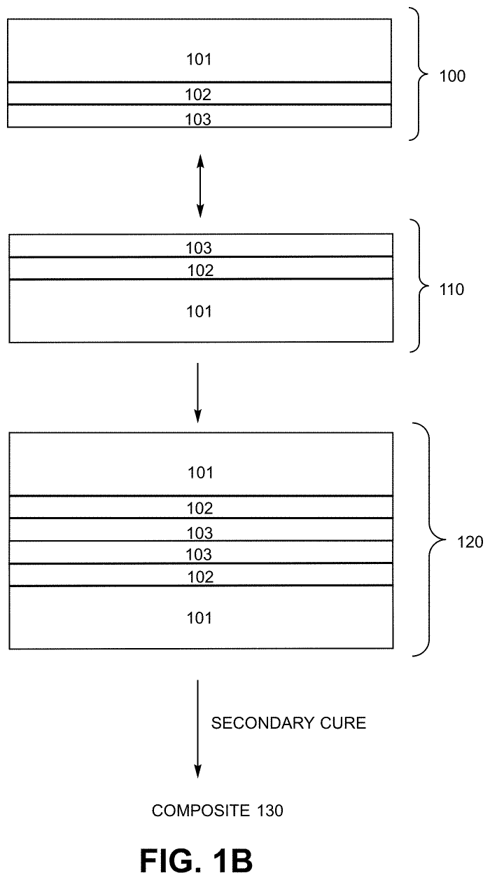

Referring to FIG. 1A, the first composite substrate 100 and the second composite substrate 110 are each composed of (i) a substrate 101 comprising a first curable resin having a first faying surface 104, (ii) a barrier ply 102 comprising a second curable resin adjacent to the first faying surface 104 of the substrate, wherein the barrier ply has a second faying surface 105, and (iii) a bonding ply 103 comprising a third curable resin adjacent to the second faying surface 105 of the barrier ply, wherein the bonding ply has a third faying surface 106. The assembly of the substrate 101, barrier ply 102, and bonding ply 103 prior to curing is depicted as 115 in FIG. 1A.

The first and second composite substrates are independently assembled and subsequently cured, which is referred to as primary curing in FIG. 1A. In one aspect, the barrier ply 102 and bonding ply 103 are sequentially coupled or applied to the substrate 101 such that the barrier ply is adjacent to the faying surface of the substrate and the bonding ply is adjacent to the faying surface of the barrier ply. In one aspect, the bonding ply 103 first and second composite substrates are composed of different curable resins. For example, the bonding ply 103 of the first composite substrate is composed of an epoxy rich resin as described below and the bonding ply 103 of the second composite substrate is composed of a hardener rich resin as described below. In other aspects, the bonding ply 103 first and second composite substrates are composed of the same or similar curable resins (e.g., each curable resin is composed an epoxy rich or hardener rich curable resin as described below).

In one aspect, the substrate, barrier ply, and bonding ply used to produce the first and second composite substrates can be individually composed of a neat curable resin, where the substrate, barrier ply, and bonding ply can be laid upon one another using techniques known in the art to produce the precursor to the first and second composite substrates.

In another aspect, the substrate, barrier ply, and bonding ply used to produce the first and second composite substrates can be individually composed of a curable resin with non-reinforcing carrier fibers (e.g., non-woven polyester carrier mat), where the substrate, barrier ply, and bonding ply can be laid upon one another using techniques known in the art to produce the precursor to the first and second composite substrates.

In one aspect, the substrate, barrier ply, and bonding ply used to produce the first and second composite substrates can be individual prepregs that can be laid upon one another using techniques known in the art to produce the precursor to the first and second composite substrates. The term “prepreg” as defined herein, refers to a layer of fibrous material (e.g. fibers, unidirectional fibers, unidirectional tows or tape, non-woven mat, and/or fabric ply) that has been impregnated with a curable resin as described herein. Prepregs may be manufactured by infusing or impregnating continuous fibers or woven fabric with a curable resin, creating a pliable and tacky sheet of material. This is often referred to as a prepregging process. The precise specification of the fibers, their orientation and the formulation of the resin matrix can be specified to achieve the optimum performance for the intended use of the prepregs. The volume of fibers per square meter can also be specified according to requirements. The fiber reinforcement material may be in the form of a woven or nonwoven fabric ply, or continuous unidirectional fibers. The term “unidirectional fibers” as used herein, refers to a layer of reinforcement fibers that are aligned in the same direction.

In one aspect, the reinforcement fibers in the prepregs may take the form of chopped fibers, continuous fibers, filaments, tows, bundles, sheets, plies, and combinations thereof. Continuous fibers may further adopt any of unidirectional (aligned in one direction), multi-directional (aligned in different directions), non-woven, woven, knitted, stitched, wound, and braided configurations, as well as swirl mat, felt mat, and chopped mat structures. Woven fiber structures may comprise a plurality of woven tows, each tow composed of a plurality of filaments, e.g. thousands of filaments. In other aspects, the one or more reinforcement fibers may include, but are not limited to, glass (including Electrical or E-glass), carbon (including graphite), aramid, polyamide, high-modulus polyethylene (PE), polyester, poly-p-phenylene-benzoxazole (PBO), boron, quartz, basalt, ceramic, and combinations thereof.

After the first composite substrate and a second composite substrate have been individually assembled to form a first stack, the first stack is cured for a sufficient time and temperature such that the substrate and barrier ply in the first composite substrate 100 and the second composite substrate 110 are fully cured and the bonding ply in the first composite substrate and the second composite substrate is partially cured. This curing step is referred to as the primary curing step. The duration and temperature applied during the primary curing step can vary depending upon the selection of the curable resins used to produce the substrate, barrier ply, and bonding ply. In one aspect, the primary curing step is conducted at a temperature of from about 25° C. to about 400° C., or about 25° C., 50° C., 75° C., 100° C., 125° C., 150° C., 175° C., 200° C., 225° C., 250° C., 275° C., 300° C., 325° C., 350° C., 375° C., or 400° C., where any value can be a lower and upper endpoint of a range (e.g., 175° C. to 250° C.).

After the first and second composite substrates 100 and 110 have been assembled and undergone primary curing, the first composite substrate to the second composite substrate are coupled to one another such that the bonding ply of the first composite substrate is adjacent to the bonding ply of the second composite substrate to produce a second stack. Coupling the two partially cured bonding plies in first and second composite substrates 100 and 110 puts the bonding ply of each composite substrate into direct physical contact with each other. This feature is depicted in FIG. 1B, where the bonding ply of each of the first and second composite substrates 100 and 110 are in adjacent to (i.e., in direct contact with) each other. The coupling of the first and second composite substrates 100 and 110 produces a second stack 120 as shown in FIG. 1.

After the second stack 120 has been assembled, the second stack is cured at a sufficient time and temperature such that the bonding ply in the first composite substrate and the second composite substrate are fully cured. This curing step is referred to as the secondary curing step as provided in FIG. 1B. The duration and temperature applied during the secondary curing step can vary depending upon the selection of the curable resins used to produce the substrate, barrier ply, and bonding ply. In one aspect, the secondary curing step is conducted at a temperature of from about 25° C. to about 400° C., or about 25° C., 50° C., 75° C., 100° C., 125° C., 150° C., 175° C., 200° C., 225° C., 250° C., 275° C., 300° C., 325° C., 350° C., 375° C., or 400° C., where any value can be a lower and upper endpoint of a range (e.g., 175° C. to 250° C.). After secondary curing is complete, the composite 130 is produced.

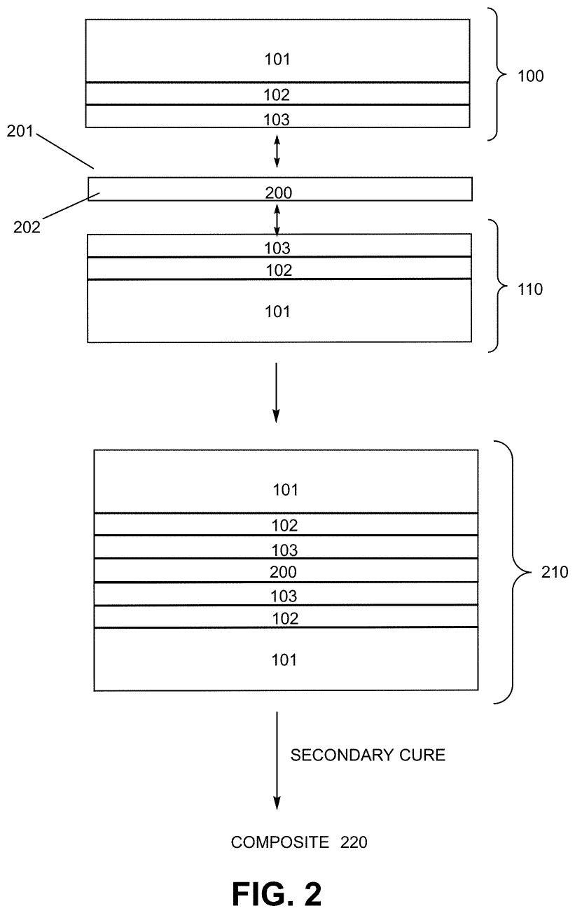

In certain aspects, a joining ply can be used to produce the composites described herein. Referring to FIG. 2, a joining ply 200 is coupled to the first composite substrate 100 and the second composite substrate 110, wherein the bonding ply of the first composite substrate and the second composite substrate is adjacent to a faying surface (201 and 202 in FIG. 2) of the joining ply to produce a third stack 210. The third stack 210 then undergoes secondary curing as described above to produce the composite 220. The use of the joining ply 200 will be discussed in greater detail below.

The substrate, barrier ply, bonding ply and optional joining ply used to produce the composites described herein include a curable resin. In one aspect, the curable resin present in the substrate, barrier ply, bonding ply and optional joining ply is the same resin material. In this aspect, once the composite has been produced, the composite is composed of the same chemical material throughout the entire composite. In one aspect, the curable resin present in the substrate, barrier ply, bonding ply and optional joining ply is a thermoset resin such as, for example, epoxies, phenolics, cyanate esters, polyimides, bismaleimides, polyesters, polyurethane, benzoxazines (including polybenzoxazines), amines, alcohols, and combinations thereof

In one aspect, the curable resin in the substrate, barrier ply, bonding ply and optional joining ply is a multifunctional epoxy resin (or polyepoxide) having a plurality of epoxide functional groups per molecule. The polyepoxide may be saturated, unsaturated, cyclic, or acyclic, aliphatic, aromatic, or hetero-cyclic polyepoxide compounds. Examples of suitable polyepoxides include the polyglycidyl ethers, which are prepared by reaction of epichlorohydrin or epibromohydrin with a polyphenol in the presence of alkali. Suitable polyphenols therefore are, for example, resorcinol, pyrocatechol, hydroquinone, bisphenol A (bis(4-hydroxyphenyl)-2,2-propane), bisphenol F (bis(4-hydroxyphenyl)-methane), fluorine 4,4′-dihydroxy benzophenone, bisphenol Z (4,4′-cyclohexy-lidene-bisphenol) and 1,5-hyroxynaphthalene.

In one aspect, the curable resin in the substrate, barrier ply, bonding ply and optional joining ply is diglycidyl ethers of bisphenol A or bisphenol F (e.g. EPONTM 828 liquid epoxy resin), DER 331, DER 661 (solid epoxy resins) available from Dow Chemical Co.; triglycidyl ethers of aminophenol (e.g. AR ALDITE.RTM. MY 0510, MY 0500, MY 0600, MY 0610 from Huntsman Corp.). Additional examples include phenol-based novolac epoxy resins, commercially available as DEN 428, DEN 431, DEN 438, DEN 439, and DEN 485 from Dow Chemical Co.; cresol-based novolac epoxy resins commercially available as ECN 1235, ECN 1273, and ECN 1299 from Ciba-Geigy Corp.; hydrocarbon novolac epoxy resins commercially available as TACTIX® 71756, TACTIX®556, and TACTIX®756 from Huntsman Corp. In some embodiments, the epoxy resin may be DER 331, which is the reaction product of epichlorohydrin and bisphenol A. The tradename DER 331 is also commonly known as bisphenol A diglycidyl ether or 2,2′-(((propane-2,2-diylbis(4,1-phenylene))bis(oxy))bis(methylene))bis(oxirane).

In one aspect, the curable resin in the substrate, barrier ply, bonding ply and optional joining ply is a tetrafunctional epoxy such as 4,4′-methylenebis(N,N-diglycidylaniline) or a trifunctional epoxy such as N,N-diglycidyl-4-glycidyloxyaniline supplied by Kaneka North America. In another aspect, the curable resin in the substrate, barrier ply, bonding ply and optional joining ply is a mixture of 4,4′-methylenebis(N,N-diglycidylaniline) and N,N-diglycidyl-4-glycidyloxyaniline.

In one aspect, the curable resin in the substrate, barrier ply, bonding ply and optional joining ply includes a hardener. The hardener contains functional groups that readily react with functional groups in the curable resin (e.g. epoxy groups) to produce highly cross-linked networks resulting in a fully cured composite structure. One common functional group used as a hardener is primary amines. Primary amines are functional groups with a H2N-. Amines suitable for use as described herein include but are not limited to 4,6-diethyl-2-methylbenzene-1,3-diamine (ethacure 100), benzene-1,2-diamine (ortho-phenylenediamine), benzene-1,3-diamine (meta-phenylenediamine), benzene-1,4-diamine (para-phenylenediamine), benzidine, 2,5-diaminotoluene, diethyltoluenediamine, or any combination thereof.

The amount of hardener present in the substrate, barrier ply, bonding ply and optional joining ply can vary. In one aspect, the curable resin in the barrier ply has a molar ratio of hardener to the epoxide in the range of from about 0.01 to about 10, or about 0.01, 0.05, 0.1, 0.5, 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, or 10, where any value can be a lower and upper endpoint of a range (e.g., 0.5 to 1.5).

In one aspect, the curable resin in the bonding ply has a molar ratio of hardener to the epoxide in the range of from about 0.01 to about 0.5, or about 0.01, 0.05, 0.1, 0.15, 0.20, 0.25, 0.30, 0.35, 0.40, 0.45, 0.50, where any value can be a lower and upper endpoint of a range (e.g., 0.05 to 0.25). In this aspect, the bonding ply is referred to as “epoxy rich” (ER), where the relative amount of curable resin to hardener is high.

In another aspect, the curable resin in the bonding ply has a molar ratio of hardener to the epoxide in the range of from about 1 to about 10, or about 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, or 10, where any value can be a lower and upper endpoint of a range (e.g., 1.5 to 3.0). In this aspect, the bonding ply is referred to as “hardener rich” (HR), where the relative amount of curable resin to hardener is low.

In one aspect, the bonding ply of the first composite substrate 100 has a molar ratio of hardener to the epoxide that is less than the molar ratio of hardener to the epoxide in the bonding ply of the second composite substrate 110. In one aspect, the bonding ply of the first composite substrate 100 has a molar ratio of hardener to the epoxide of from about 0.01 to about 0.5 (epoxy rich) and the bonding ply of the second composite substrate 110 has a molar ratio of hardener to the epoxide of from about 1 to about 10 (hardener rich).

The amount of curable resin present in the substrate, barrier ply, bonding ply and optional joining ply can vary. In one aspect, the amount of curable resin present in the barrier ply is from about 20 wt % to about 100 wt %, or about 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, 90 wt %, 95 wt %, or 100 wt %, where any value can be a lower and upper endpoint of a range (e.g., 25 wt % to 40 wt %). In another aspect, the amount of curable resin present in the bonding ply is from about 20 wt % to about 100 wt %, or about 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, 90 wt %, 95 wt %, or 100 wt %, where any value can be a lower and upper endpoint of a range (e.g., 25 wt % to 40 wt %). When the curable resin is present at 100 wt % of the barrier or bonding ply, the barrier or bonding ply does not include additional components such as, for example, reinforcement fibers.

The degree of cure of the curable resin present in the substrate, barrier ply, and bonding ply prior to primary curing can vary. In one aspect, the curable resin in the substrate, barrier ply, and bonding ply prior to primary curing can have a degree of cure less than 80%, or about 10%, 15%, 20%, 25%, 30%, 35%, 40%, 45%, 50%, 55%, 60%, 65%, 70%, 75%, or 80%, where any value can be a lower and upper endpoint of a range (e.g., 10% to 40%).

The barrier ply material can be prepared by advancing the cure state of the curable resin. In one aspect, the advancement in terms of degree of cure (% DoC) can be minimal (e.g., 5-10% DoC) to allow maximum mixing to occur or can be high (e.g., 35-60% DoC). The limiting DoC is the gel point as the barrier ply will not integrate into the laminate if the resin is beyond the gel point. Barrier ply material can be prepared by heating the curable resin to drive the polymerization reaction and increase the DoC to the desired level. This process is often referred to as B-staging. The B-stage process can be applied to the neat curable resin or to prepreg material prior to layup on the preform. The time, temperature, and resulting DoC depend on the selection of the resin chemistry, catalysts, and processing conditions such as mixing and solvents.

The thickness of the substrate, barrier ply, bonding ply and optional joining ply can vary depending upon the application of the composite. In one aspect, the barrier ply has a thickness of from about 5 μm to about 500 μm, or about 5 μm, 10 μm, 50 μm, 100 μm, 150 μm, 200 μm, 250 μm, 300 μm, 350 μm, 400 μm, 450 μm, or 500 μm, where any value can be a lower and upper endpoint of a range (e.g., 50 μm to 250 μm). In another aspect, the bonding ply has a thickness of from about 50 μm to about 300 μm, or about 50 μm, 100 μm, 150 μm, 200 μm, 250 μm, 300 μm, where any value can be a lower and upper endpoint of a range (e.g., 100 μm to 250 μm).

In one aspect, the barrier ply comprises prepreg tape comprising reinforcement fibers. In another aspect, the barrier ply comprises reinforcement fibers at a fiber areal weight of from about 10 g/m² to about 500 g/m², or about 10 g/m², 50 g/m², 100 g/m², 150 g/m², 200 g/m², 250 g/m², 300 g/m², 350 g/m², 400 g/m², 450 g/m², or 500 g/m², where any value can be a lower and upper endpoint of a range (e.g., 150 g/m² to 450 g/m²). In another aspect, the barrier ply comprises prepreg tape comprising reinforcement fibers, an epoxide resin, and a hardener comprising an amine, wherein the molar ratio of the hardener to the epoxide is from about 0.01 to about 10.

In one aspect, the bonding ply comprises prepreg tape comprising reinforcement fibers. In another aspect, the bonding ply comprises prepreg tape comprising reinforcement fibers, an epoxide resin, and a hardener comprising an amine, wherein the molar ratio of the hardener to the epoxide is from about 1 to about 10.

In certain aspects, a joining ply can be used to produce the composites described herein. For example, when the bonding ply of the first composite substrate 100 and second composite 110 are epoxy rich curable resins, the joining ply 200 can be coupled to the bonding ply of each substrate as depicted in FIG. 2. In this aspect, the joining ply 200 can be a hardener rich curable resin. In one aspect, the curable resin in the joining ply has a molar ratio of hardener to the epoxide in the range of from about 0.01 to about 10, or about 0.01, 0.05, 0.1, 0.5, 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, or 10, where any value can be a lower and upper endpoint of a range (e.g., 2.0 to 3.5). Once the stack with the joining ply has been assembled (210 in FIG. 2), the stack undergoes secondary curing to produce the final composite product.

In certain aspects, the curable resin in the substrate, barrier ply, bonding ply and optional joining ply can include one or more additives, fillers, and fibers, such as, but not limited to, chopped or continuous glass fiber, metal fibers, aramid fibers, carbon fibers, or ceramic fibers, surfactants, organic binders, polymeric binders, crosslinking agents, diluents, coupling agents, flame-retardant agents, anti-dripping agents such as fluorinated polyolefins, silicones, and, lubricants, mold release agents such as pentaerythritol tetrastearate, nucleating agents, anti-static agents such as conductive blacks, carbon nanotubes, graphite, graphene, oxidized graphene, and organic antistatic agents such as polyalkylene ethers, alkylsulfonates, perfluoro sulfonic acid, perfluorobutane, sulfonic acid potassium salt, and polyamide-containing polymers, catalysts, colorants, inks, dyes, antioxidants, stabilizers, and the like and any combinations thereof

In one aspect, the additional components or additives can be from about 0.001 wt. % to about 1 wt. %, about 0.005 wt. % to about 0.9 wt. %, about 0.005 wt. % to about 0.8 wt. %, or about 0.04 wt. % to about 0.8 wt. % of the curable resin in the substrate, barrier ply, bonding ply and optional joining ply, and in particular embodiments, the additional components or additives may make up about 0.04 wt. % to about 0.6 wt. % based on the curable resin in the substrate, barrier ply, bonding ply and optional joining ply. Additional components such as glass fiber, carbon fiber, organic fiber, ceramic fiber or other fillers may be provided at much higher concentrations up to 70 volume (vol.) %.

For example, the curable resin in the substrate, barrier ply, bonding ply and optional joining ply may include about 5 vol. % to about 70 vol. %, from about 10 vol. % to about 60 vol. %, or about 20 vol. % to about 50 vol. % glass fiber, carbon fiber, organic fiber, or ceramic fiber.

In one aspect, curing agents (or curatives) can slow the cure rate of the curable resin. The curatives may be selected from well-known curatives with reactivities that are well established. For instance, curatives for epoxy resins in order of increasing curing rate are generally classified as: polymercaptan<polyamide<aliphatic polyamine<aromatic polyamine derivatives<tertiary amine boron trifluoride complex<acid anhydride<imidazole<aromatic polyamine<cyanoguanadine<phenol novolac. This list is only a guide and overlap within classifications exists. Curatives of the surface treatment layer are generally selected from groups that are listed towards the higher end of the reaction order, whereas the composite substrate's curatives may be generally selected from groups towards the beginning of the reaction order.

Curing agents, curing catalysts, and curing accelerators known in the art such useful herein include, but are not limited to, transition metal catalysts, tertiary amines, imidazole containing compounds, and the like and combinations thereof. Examples of the tertiary amine curing catalysts include triethylamine, benzyldimethylamine, pyridine, picoline, 1,8-diazabiscyclo(5,4,0)undecene-1, dicyandiamide, and the like, and Examples of the imidazole compound include, but are not limited to 2-methylimidazole, 2-ethylimidazole, 2-undecylimidazole, 2-ethyl-4-methylimidazole, 2-phenyl-4,5-dihydroxymethylimidazole, 2-phenyl imidazole, phosphonium salts like tetraphenyl phosphonium phenolate and ethyltriphenyl phosphonium bromide, tetrabutyl ammonium, 4-dimethylaminopyridine, and boron trifluoride-ethylamine complex and the like.

Some non-limiting examples of curatives that may be used include, but are not limited to, melamine and substituted melamine derivatives, aliphatic and aromatic primary amines, aliphatic and aromatic tertiary amines, boron trifluoride complexes, guanidines, dicyandiamide, bisureas (including 2,4-toluene bis-(dimethyl urea), commercially available as CA 150 from CVC Thermoset Specialties), 4,4′-Methylene bis-(phenyl dimethylurea), e.g. CA 152 from CVC Thermo-set Specialties), 4,4′-diaminodiphenylsulfone (4,4-DDS), and combinations thereof

Cure inhibitors are molecules that slow the rate of reaction between the curable resins and curatives. Examples of suitable cure inhibitors include, but are not limited to, boric acid, trifluoroborane, and derivatives thereof such as alkyl borate, alkyl borane, trimethoxyboroxine and organic acids having a pKa from 1 to 3 such as maleic acid, salicyclic acid, oxalic acid and mixtures thereof. Other inhibitors include metal oxides, metal hydroxides, and alkoxides of metal, where the metal is zinc, tin, titanium, cobalt, manganese, iron, silicon, boron, or aluminum. When such inhibitor is used, the amount of inhibitor may be up to about 15 parts per hundred parts of resin or PHR, for example, about 1 to about 5 PHR, in a resin composition. “PHR” is based on the total weight of all resins in the resin composition.

Catalysts facilitate the polymerization and crosslinking reactions of the curable resins. Some examples of suitable catalysts include compounds containing amine, phosphine, heterocyclic nitrogen, ammonium, phosphonium, arsenium, or sulfonium moieties. In other embodiments, heterocyclic nitrogen-containing and amine-containing compounds may be used such as, for example, imidazoles, imidazolidines, imidazolines, benzimidazoles, oxazoles, pyrroles, thiazoles, pyridines, pyrazines, morpholines, pyridazines, pyrimidines, pyrrolidines, pyrazoles, quinoxalines, quinazolines, phthalozines, quinolines, purines, indazoles, indoles, indolazines, phenazines, phenarsazines, phenothiazines, pyrrolines, indolines, piperidines, piperazines, and combinations thereof. When such catalysts are used, the amount of catalyst(s) may be up to about 15 parts per hundred parts of resin or PHR, for example, about 1 to about 5 PHR, in a resin composition.

The amount of the curing catalyst may be any amount that is effective for use as a catalyst and can, generally, be from about 0.01 wt. % to about 20 wt. % based on the weight of the total composition. In some embodiments, the amount of curing catalyst may be, about 0.1 wt. % to about 15 wt. %, about 0.5 wt. % to about 10 wt. %, about 1.0 wt. % to about 5 wt. %, or any range or individual concentration encompassed by these example ranges.

Inorganic fillers in particulate form (e.g. powder) may also be added to the curable resins as a rheology modifying component to control the flow of the resin composition and to prevent agglomeration therein. Suitable inorganic fillers include, but are not limited to, fumed silica, talc, mica, calcium carbonate, alumina, ground or precipitated chalks, quartz powder, zinc oxide, calcium oxide, and titanium dioxide. If present, the amount of fillers in the resin composition may be from about 0.5% to about 40% by weight, or about 1% to about 10% by weight, or about 1% to about 5% by weight, based on the total weight of the resin composition.

Organic fillers may also be added to the curable resins in order to modify the mixing and flow of the resin. In one aspect, the organic filler can possess functional groups that react with the curable resin. For example, the organic filler can be a thermoplastic polymer with functional groups (e.g., amine groups) incorporated in the polymer backbone and/or pendant to the polymer backbone that can react with functional groups (e.g., epoxy groups) in the curable resin.

Aspects

Aspect 1. A method for producing a composite comprising:
(a) providing a first composite substrate and a second composite substrate, wherein the first composite substrate and the second composite substrate each comprises
   (i) a substrate comprising a first curable resin having a first faying surface,
   (ii) a barrier ply comprising a second curable resin adjacent to the first faying surface of the substrate, wherein the barrier ply has a second faying surface, and
   (iii) a bonding ply comprising a third curable resin adjacent to the second faying surface of the barrier ply, wherein the bonding ply has a third faying surface, wherein the substrate and barrier ply in the first composite substrate and the second composite substrate are fully cured and the bonding ply in the first composite substrate and the second composite substrate is partially cured;
(b)(1) coupling the first composite substrate to the second composite substrate, wherein the bonding ply of the first composite substrate is adjacent to the bonding ply of the second composite substrate to produce a first stack, or (2) coupling the first composite substrate to the second composite substrate by a joining ply comprising a fourth curable resin, wherein the bonding ply of the first composite substrate and the second composite substrate is adjacent to a faying surface of the joining ply to produce a first stack; and
(c) curing the first stack to fully cure the bonding ply in the first composite substrate and the second composite substrate to produce the composite.

Aspect 2. The method of Aspect 1, wherein the barrier ply comprises a preppreg tape comprising reinforcement fibers.

Aspect 3. The method of Aspect 1 or 2, wherein the second curable resin of the barrier ply comprises an epoxide and a hardener.

Aspect 4. The method of Aspect 3, wherein the hardener comprises an amine.

Aspect 5. The method of Aspect 3, wherein the molar ratio of the hardener to the epoxide is from about 0.01 to about 10.

Aspect 6. The method of any one of Aspects 1-5, wherein the second curable resin has a degree of cure less than 80%.

Aspect 7. The method of any one of Aspects 1-5, wherein the second curable resin has a degree of cure at from about 10% to about 40%.

Aspect 8. The method of any one of Aspects 1-7, wherein the barrier ply comprises prepreg tape comprising reinforcement fibers, an epoxide resin, and a hardener comprising an amine, wherein the molar ratio of the hardener to the epoxide is from about 0.01 to about 10.

Aspect 9. The method of any one of Aspects 1-8, wherein the barrier ply comprises reinforcement fibers at a fiber areal weight of from about 10 g/m² to about 500 g/m².

Aspect 10. The method of any one of Aspects 1-9, wherein the second curable resin is from about 20 wt % to about 100 wt % of the barrier ply.

Aspect 11. The method of any one of Aspects 10, wherein the barrier ply has a thickness of from about 5 μm to about 500 μm.

Aspect 12. The method of any one of Aspects 1-11, wherein the bonding ply comprises a preppreg tape comprising reinforcement fibers and the third curable resin.

Aspect 13. The method of any one of Aspects 1-12, wherein the third curable resin comprises an epoxide and a hardener.

Aspect 14. The method of Aspect 13, wherein the molar ratio of the hardener to the epoxide is from about 0.01 to about 0.5.

Aspect 15. The method of any one of Aspects 1-14, wherein the bonding ply has a thickness of from about 50 μm to about 300 μm.

Aspect 16. The method of any one of Aspects 1-15, wherein the joining ply comprises a preppreg tape comprising reinforcing fibers.

Aspect 17. The method of any one of Aspects 1-16, wherein the fourth curable resin comprises an epoxide and a hardener.

Aspect 18. The method of Aspect 17, wherein the molar ratio of the hardener to the epoxide is from about 1 to about 10.

Aspect 19. A composite produced by the method of any one of Aspects 1-18.

Aspect 20. A cured composite comprising:
a first composite substrate and a second composite substrate, wherein the first composite substrate and the second composite substrate each comprises
   (i) a substrate comprising a first curable resin having a first faying surface,
   (ii) a barrier ply comprising a second curable resin adjacent to the first faying surface of the substrate, wherein the barrier ply has a second faying surface, and
   (iii) a bonding ply comprising a third curable resin adjacent to the second faying surface of the barrier ply, wherein the bonding ply has a third faying surface, wherein the bonding ply of the first composite substrate is adjacent to the bonding ply of the second composite substrate.

Aspect 21. A cured composite comprising:
(a) a first composite substrate and a second composite substrate, wherein the first composite substrate and the second composite substrate each comprises
   (i) a substrate comprising a first curable resin having a first faying surface,
   (ii) a barrier ply comprising a second curable resin adjacent to the first faying surface of the substrate, wherein the barrier ply has a second faying surface, and
   (iii) a bonding ply comprising a third curable resin adjacent to the second faying surface of the barrier ply, wherein the bonding ply has a third faying surface,
(b) a joining ply, wherein the bonding ply of the first composite substrate and the second composite substrate is adjacent to a faying surface of the joining ply.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure.

Experimental

Epoxy resins were formulated from two components: API60® (part A) epoxy resin composed of a mixture of tetrafunctional and trifunctional epoxy resins supplied by Kaneka North America and diethyltoluenediamine (DETDA, part B) hardener supplied by Alpha Chemistry.

Resins were formulated from parts A and B in a resin kettle in 1.2 kg batches by heating to 100° C. and agitating with an overhead mechanical stirrer for 60 min for ER resins and 90 min for HR resins once the resin was sufficiently heated to allow stirring. To fabricate mechanical test specimens, prepreg was prepared from HexTow® IM7G carbon fiber from Hexcel® and offset resins with r-values of 0.15 and 2.5 for the ER and HR plies, respectively. Methyl ethyl ketone (MEK), from Sigma Aldrich, was used to dilute the resin to 85 wt % polymer for prepreg preparation. Hexply® IM7/8552, 35wt % resin content, 190 g/m² tape (“conventional material”) was obtained from Hexcel Corporation® and used as backing for the mechanical test specimens.

BP material was prepared with an r-value of 0.8 from API-60® (part A) and diaminodiphenylsulphone hardener obtained from Kaneka North America. The prepreg had a fiber areal weight of ˜45 g/m² and a resin content of ˜52 wt %. The prepreg was advanced by pressing 30 mm×75 mm pieces of tape between steel plates and heating at 110° C. for 150, 225, or 300 min to obtain various cure states. One ply of BP material was used in each experimental layup. BP degree of cure (DoC_{BP}) was estimated with RAVEN® (Convergent Manufacturing Technologies®) software assuming cure kinetics similar to Hexcel® 8552 resin.

Unidirectional prepreg tape was prepared using a custom tape machine. Unidirectional, composite panels were prepared by hand laying the Hexcel® and ER prepregs in a 30 cm by 15 cm format according to [Conventional₉/BPₘ/ERₙ/HR]s, where m=0 or 1 and n=1 or 2. Panels were autoclave cured using the two-step process. Primary cure produced two composite substrates. The composite substrates were then assembled with two plies of HR material in contact with the ER surfaces and returned to the autoclave for secondary cure.

Resin chemistry was characterized by infrared spectroscopy (IR) to determine the r-value at the surface after primary cure (r_{IR}). The r_{IR} values were calculated based on the relative peak heights at 907 and 1450 cm⁻¹ in reference to 1514 cm⁻¹ using a calibration curve developed from a series of resins of known r-values and degree of cure. Prior to machining, ultrasonic inspection in pulse-echo mode was conducted on a MISTRAS® UPK-T60-HS high-speed C-scan system fitted with an NDT Automation® 10.0 MHz, 13 mm element size immersion transducer (IU10G1). Laminates were machined into six, 20.3×152 mm specimens using an abrasive water jet cutter. ENF testing was conducted according to ASTM 7905-14 to measure mode II fracture toughness (G_{IIc-PC}) using six replicate specimens.⁵ Machined specimens were inspected ultrasonically prior to and after mechanical testing to observe, respectively, the crack front location and damage progression. The shear fracture toughness is reported for pre-cracked specimens meaning the crack was extended from the manufactured crack tip to obtain a naturally sharp crack tip prior to measuring the toughness.

### Results and Discussion

Table 1 summarizes the results for five laminates prepared and tested using the BP concept and two control laminates, A1 and A2, which did not contain a BP. A baseline mode-II fracture toughness of 855 J/m² was measured from a co-cured laminate fabricated entirely from conventional material. The baseline value was compared with experimental results.

TABLE 1
Summary of BP experimental results. Results are shown for shear
fracture toughness of precracked specimens (G_{IIc-PC}), the percent
of baseline fracture properties (% G), the post-primary cure r-value
determined by FTIR (r_{IR}), the thickness of the cured ER layer (d_{ER}),
and the estimated degree of cure of the BP layer (% DoC_{BP}).

| | | G_{IIc-PC} | | d_{ER} | |
|---|---|---|---|---|---|
| Sample | % G | (J/m²) | r_{IR} | (μm) | % DoC_{BP} |
| A1^{a} | 0 | Delam.^{b} | 0.13 | 212^{c} | N/A |
| A2^{a} | 92 | 787 | 0.12 | 425 | N/A |
| B | 0 | Delam.^{b} | 0.20 | 115^{c} | 15 |
| C | 43 | 364 | 0.31 | 145 | 25 |
| D | 99 | 848 | 0.15 | 85 | 35 |
| E | 111 | 947 | 0.15 | 287 | 25 |
| F | 101 | 863 | 0.14 | 127 | 35 |

^{a}Control (no BP included)
^{b}Panel delaminated prior to mechanical testing, and thickness of the cured ER layer could not be measured directly.
^{c}Estimated from uncured prepreg properties.

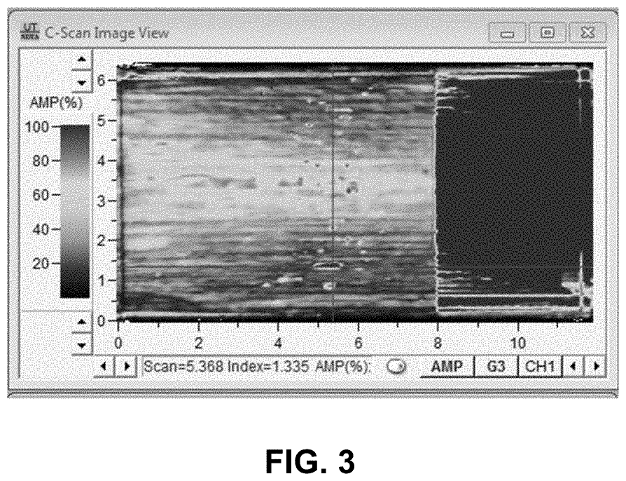

Sample A1 control contained no BP layer and a single ply of ER material (212 μm thick). Although the laminate appeared to be joined after secondary cure, ultrasonic inspection indicated large delaminations in the center of the laminate (red/yellow areas in center of FIG. 3). The sample delaminated during machining into ENF specimens such that it could not be tested for fracture toughness. The r_{IR} result for sample A1, was anomalously low and contradicted the poor mechanical performance. Sample A2 control had no BP layer, but contained two plies of ER material with a total thickness of 425 μm. This sample experienced no delamination prior to testing and exhibited a fracture toughness that was 92% of the baseline material, which correlated well with the low r_{IR} value. These tests indicate that a thick ER layer is needed to obtain a strong bond during secondary cure processing. A thin ER layer likely experiences excessive mixing and advancement with conventional resin during the primary cure thus leaving insufficient resin to reflow during secondary cure to form a strong bond.

Samples B-F tested the effect of the DOC_{BP} and the effect of ER layer thickness on IR response and bond performance, as indicated in Table 1. A BP with low DoC is likely to reflow and develop good mechanical properties during cure but may not sufficiently reduce mixing with the ER layer. A BP ply with high DoC will likely reduce intermixing between conventional and ER resins but may not develop full mechanical performance during cure. DoC_{BP} values from 15 to 35% were explored as well as ER layer thicknesses (d_{ER}) from 85 to 287 μm.

In Sample B, a single ply of ER, ˜115 μm thick, was placed on the 5% DoC BP layer. The result was a slightly elevated r_{IR} (0.2) indicating advancement of the ER surface resin, and no bonding after secondary cure. Sample B delaminated completely during machining into ENF specimens. Sample C had a BP layer with 25% DoC and a single ply of ER material. In this experiment, the r_{IR} value was anomalously high, but the specimens remained intact during machining and exhibited 43% of baseline fracture toughness. Sample D had a BP ply with 35% DoC and a single ply of ER material. The resulting laminate had a low r_{IR} (0.15) indicating the surface resin had not advanced in cure state, and the fracture toughness nearly matched (99%) baseline performance.

Samples E and F both had two plies of ER materials and 25% and 35% DoC in the BP layer, respectively. In both laminates, the r_{IR} values were low (≤0.15), which indicated the surfaces were not excessively advanced during primary cure. The fracture toughness reached 111% and 101% for E and F, respectively, correlating well with r_{IR} measurements.

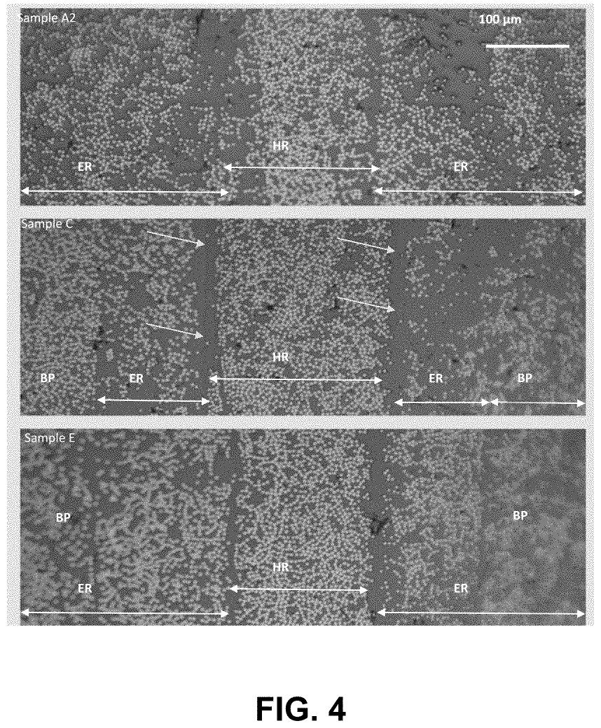

Micrographs from polished cross-sections of Samples A2, C, and E are shown in FIG. 4. Sample A2 shows no visible interface between the ER and HR layers after secondary cure indicating good intermixing of the layers, which leads to good mechanical performance. Sample C shows a visible interface indicating poor intermixing, which led to interfacial failure and low toughness. Sample E, in spite of a somewhat reduced ER layer thickness, showed no visible interface and exhibited cohesive failure with high toughness during mechanical testing. Conclusion

Stoichiometrically offset epoxy resins were developed to enable assembly of large, complex composite structures with reliable, co-cured joints. To reduce the thickness of ER-HR-ER joints, a barrier-ply concept was studied. BP materials with 25% and 35% DoC appeared to prevent excessive mixing between conventional and ER resins during primary cure, which prevented the DoC on the ER surface from advancing. The ER layer thickness was successfully reduced to 85 μm and a fracture toughness of 99% of the baseline value was obtained. Fracture toughness up to 111% of baseline was obtained for moderate ER layer thickness. These data suggest that controlling the extent of resin intermixing during the primary cure step is critical to maximizing joint mechanical properties.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

What is claimed is:

1. A method for producing a composite comprising:
(b) providing a first composite substrate and a second composite substrate, wherein the first composite substrate and the second composite substrate each comprises
(iv) a substrate comprising a first curable resin having a first faying surface,
(v) a barrier ply comprising a second curable resin adjacent to the first faying surface of the substrate, wherein the barrier ply has a second faying surface, and
(vi) a bonding ply comprising a third curable resin adjacent to the second faying surface of the barrier ply, wherein the bonding ply has a third faying surface, wherein the substrate and barrier ply in the first composite substrate and the second composite substrate are fully cured and the bonding ply in the first composite substrate and the second composite substrate is partially cured;
(b)(1) coupling the first composite substrate to the second composite substrate, wherein the bonding ply of the first composite substrate is adjacent to the bonding ply of the second composite substrate to produce a first stack, or (2) coupling the first composite substrate to the second composite substrate by a joining ply comprising a fourth curable resin, wherein the bonding ply of the first composite substrate and the second composite substrate is adjacent to a faying surface of the joining ply to produce a first stack; and
(c) curing the first stack to fully cure the bonding ply in the first composite substrate and the second composite substrate to produce the composite.

2. The method of claim 1, wherein the barrier ply comprises a preppreg tape comprising reinforcement fibers.

3. The method of claim 1, wherein the second curable resin of the barrier ply comprises an epoxide and a hardener.

4. The method of claim 3, wherein the hardener comprises an amine.

5. The method of claim 3, wherein the molar ratio of the hardener to the epoxide is from about 0.01 to about 10.

6. The method of claim 1, wherein the second curable resin has a degree of cure less than 80%.

7. The method of claim 1, wherein the second curable resin has a degree of cure at from about 10% to about 40%.

8. The method of claim 1, wherein the barrier ply comprises prepreg tape comprising reinforcement fibers, an epoxide resin, and a hardener comprising an amine, wherein the molar ratio of the hardener to the epoxide is from about 0.01 to about 10.

9. The method of claim 1, wherein the barrier ply comprises reinforcement fibers at a fiber areal weight of from about 10 g/m² to about 500 g/m².

10. The method of claim 1, wherein the second curable resin is from about 20 wt % to about 100 wt % of the barrier ply.

11. The method of claim 1, wherein the barrier ply has a thickness of from about 5 μm to about 500 μm.

12. The method of claim 1, wherein the bonding ply comprises a preppreg tape comprising reinforcement fibers and the third curable resin.

13. The method of claim 1, wherein the third curable resin comprises an epoxide and a hardener.

14. The method of claim 13, wherein the molar ratio of the hardener to the epoxide is from about 0.01 to about 0.5.

15. The method of claim 1, wherein the bonding ply has a thickness of from about 50 μm to about 300 μm.

16. The method of claim 1, wherein the joining ply comprises a preppreg tape comprising reinforcing fibers.

17. The method of claim 1, wherein the fourth curable resin comprises an epoxide and a hardener.

18. A composite produced by the method of claim 1.

19. A cured composite comprising:
a first composite substrate and a second composite substrate, wherein the first composite substrate and the second composite substrate each comprises
(i) a substrate comprising a first curable resin having a first faying surface,
(ii) a barrier ply comprising a second curable resin adjacent to the first faying surface of the substrate, wherein the barrier ply has a second faying surface, and
(iii) a bonding ply comprising a third curable resin adjacent to the second faying surface of the barrier ply, wherein the bonding ply has a third faying surface, wherein the bonding ply of the first composite substrate is adjacent to the bonding ply of the second composite substrate.

20. A cured composite comprising:
(a) a first composite substrate and a second composite substrate, wherein the first composite substrate and the second composite substrate each comprises
(iv) a substrate comprising a first curable resin having a first faying surface,
(v) a barrier ply comprising a second curable resin adjacent to the first faying surface of the substrate, wherein the barrier ply has a second faying surface, and
(vi) a bonding ply comprising a third curable resin adjacent to the second faying surface of the barrier ply, wherein the bonding ply has a third faying surface,
(b) a joining ply, wherein the bonding ply of the first composite substrate and the second composite substrate is adjacent to a faying surface of the joining ply.
